(19) United States
(12) Patent Application Publication
(10) Pub. No.: US 2007/0244968 A1
(43) Pub. Date: Oct. 18, 2007

(54) METHOD AND ARRANGEMENT IN A COMMUNICATIONS NETWORK

(75) Inventor: Markus ANDREASSON, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/466,297

(22) Filed: Aug. 22, 2006

Related U.S. Application Data
(60) Provisional application No. 60/745,026, filed on Apr. 18, 2006.

(51) Int. Cl. G06F 15/16

(52) U.S. Cl. 709/204

(57) ABSTRACT

A first portable communication device may include a chat client; an activity application that is settable in a state; a chat start application; a first input device adapted to activate the activity application and set the activated activity application in a specific state; a second input device for activating the chat start application; and a keyword generating unit for creating, in response to the chat start application being activated; a specific keyword for the activated activity application set in a specific state. The chat client may send a chat request to the chat server in response to the chat start application being activated. The request may include the specific keyword.

### RELATED APPLICATION

This application claims priority under 35 U.S.C. § 119 based on U.S. Provisional Application Ser. No. 60/745,026, filed Apr. 18, 2006, the disclosure of which is incorporated herein by reference.

### FIELD OF THE INVENTION

Implementations consistent with principles of the invention relate generally to a method and arrangement in a portable communication device and a method and arrangement in a chat server. In particular, implementations consistent with principles of the invention relate to managing a chat room associated with an ongoing state in an activity application.

### BACKGROUND OF THE INVENTION

It is known within the field of portable communication devices, such as, e.g., cellular phones, to use the portable communication devices in different activities, such as to listen to music or radio, playing games, taking a photo, watching videos or TV, watching a specific site on the internet etc. This is possible if the portable communication device comprises an activity application such as a music, radio, game, video or TV application.

It is furthermore known within the field of portable communication devices, such as e.g., cellular phones, to use the portable communication devices for instant messaging or “chatting” in communication sessions between two or more different parties. In this situation, the portable communication device may include a so-called chat application. Introduction of the chat service may involve the user obtaining the settings required by the service for his/her communication device. The settings allow the portable communication device to connect to a special instant message server and to exchange messages with other portable communication devices through the server. Such settings may include, e.g., the address, a user identifier (ID), and the password. The user may decide which chat room to enter when connecting to such a server.

### SUMMARY OF THE INVENTION

According to a first embodiment, a method in a first portable communication device, for managing a chat room is disclosed. The method includes a chat client, an activity application, and a chat start application. The first portable communication device may be adapted to connect to a chat server. The method may comprise activating the activity application; setting the activated activity application to a specific state; activating the chat start application; creating, in response to activating the chat start application, a specific keyword associated with the activated activity application set in a specific state; sending, in response to the activating the chat start application, a chat request to the chat server, the chat request comprising the specific keyword.

A second embodiment is directed towards a method including the features of the first embodiment, where the method further comprises receiving a first notification from the chat server, the first notification comprising information about a specific chat room in the chat server, the specific chat room being associated with the specific state of the activity application defined by the specific keyword.

A third embodiment is directed towards a method including the features of the first embodiment, where the first notification further comprises information that the user of the first device has entered the specific chat room.

A fourth embodiment is directed towards a method including the features of the first embodiment, where the method further comprises displaying the specific chat room to the user of the first device.

A fifth embodiment is directed towards a method including the features of the first embodiment, where the method further comprises receiving of a second notification from the chat server comprises information about another user of a second device being in the specific chat room, which other user has activated a same specific state of an activity application in the second device.

A sixth embodiment is directed towards a method including the features of the fifth embodiment, where the method further comprises displaying an identity of the other user being in the specific chat room.

According to a seventh embodiment, a computer program for managing a specific chat room comprises a computer program code for causing a processing means within a first portable communication device to control an execution of the features of the first embodiment.

According to an eighth embodiment, a first portable communication device is disclosed. The first portable communication device comprises a chat client; an activity application that is settable in a state; a chat start application; a first input device adapted to activate the activity application and set the activated activity application in a specific state; a second input device for activating the chat start application; and a keyword generating unit for creating, in response to the chat start application being activated, a specific keyword for the activated activity application set in a specific state. The chat client sends a chat request to the chat server in response to the chat start application being activated. The chat request comprises the specific keyword.

A ninth embodiment is directed towards a first portable communication device including the features of the eighth embodiment, where the chat client is adapted to receive a first notification from the chat server, the first notification comprising information about a specific chat room in the chat server, the specific chat room being associated with the specific state of the activity application defined by the specific keyword.

A tenth embodiment is directed towards a first portable communication device including the features of the eighth embodiment, where the first notification further comprises information that the user of the first portable communication device has entered the specific chat room.

An eleventh embodiment is directed towards a first portable communication device including the features of the eighth embodiment, where the first portable communication device further comprises a display device adapted to display the specific chat room to the user of the first portable communication device.

A twelfth embodiment is directed towards a first portable communication device including the features of the eighth embodiment, where the chat client further is adapted to receive a second notification from the chat server, the second notification comprising information about another user of a second device being in the specific chat room, which other user has activated a same specific state of an activity application in the second device.

A thirteenth embodiment is directed towards a first portable communication device including the features of the eleventh embodiment, where the display device is further adapted to display an identity of the other user being in the specific chat room.

A fourteenth embodiment is directed towards a first portable communication device including the features of the twelfth embodiment, where the chat client further is adapted to set up a chat session between the first portable communication device and the second device in the specific chat room.

A fifteenth embodiment is directed towards a first portable communication device including the features of the eighth embodiment, wherein the first portable communication device is a mobile phone.

According to a sixteenth embodiment, a method comprises receiving, from a chat client of a first portable communication device, a chat request comprising a specific keyword, which specific keyword is associated with an activated activity application set in a specific state by a user of the first portable communication device; and creating a specific chat room associated with the specific state of the activity application according to the specific keyword, if no such chat room already exists.

A seventeenth embodiment is directed towards a method including the features of the sixteenth embodiment, where the method further comprises identifying the specific state of the activity application associated with the specific keyword.

An eighteenth embodiment is directed towards a method including the features of the sixteenth embodiment, where the method further comprises entering the user into the created specific chat room.

A nineteenth embodiment is directed towards a method including the features of the sixteenth embodiment, where the method further comprises sending a first notification to the chat client of the first portable communication device, the first notification comprising the information about the created specific chat room being associated with the specific state of the activity application and that the user of the first portable communication device has entered the created specific chat room.

A twentieth embodiment is directed towards a method including the features of the sixteenth embodiment, where the method further comprises determining if any specific chat room associated with the activated activity application set in the specific state already exits within the chat server, which specific chat room, if it exists, comprises at least one other user of a second portable communication device, that has activated an activity application set in a same specific state as the user of the first portable communication device.

A twenty-first embodiment is directed towards a method including the features of the twentieth embodiment, where the method further comprises entering the user of the first portable communication device into the existing specific chat room, if a specific chat room exists.

A twenty-second embodiment is directed towards a method including the features of the twenty-first embodiment, where the method further comprises sending a first notification to the chat client of the first portable communication device, the first notification comprising information about the existing specific chat room being associated with the specific state of the activity application, that the user of the first portable communication device has entered the chat room and that the at least one other user of the second portable communication device is also in the specific chat room.

A twenty-third embodiment is directed towards a method including the features of the twenty-first embodiment, where the chat server is adapted to communicate with a chat client in at least one second portable communications device via the infrastructure network. The method further comprises sending a second notification to each of the chat clients of the at least one second portable communication device, the second notification comprising information that the user of the first portable communication device has entered the specific chat room.

A twenty-fourth embodiment is directed towards a method including the features of the twenty-first embodiment, where the method further comprises setting up a chat session between the user of the first portable communication device and the at least one other user of the second portable communication device.

A twenty-fifth embodiment is directed towards a method including the features of the sixteenth embodiment, where a computer program product for managing a specific chat room, comprising computer program code for causing a processing means with the chat server to control an execution of the method of the sixteenth embodiment.

According to a twenty-sixth embodiment, a chat server is disclosed. The chat server comprises a chat request receiving unit adapted to receive a chat request from a chat client of a first device. The chat request comprising a specific keyword, which specific keyword is associated with an activated activity application set in a specific state by a user of the first device. The chat server further comprises a chat room managing unit adapted to create a specific chat room associated with the specific state of the activity application according to the specific keyword.

A twenty-seventh embodiment is directed towards a chat server including the features of the twenty-sixth embodiment, where the chat server further comprises a keyword processing unit adapted to identify the specific state of the activity application associated with the specific keyword.

A twenty-eighth embodiment is directed towards a chat server including the features of the twenty-sixth embodiment, wherein the chat room managing unit is further adapted to enter the user into the created specific chat room.

A twenty-ninth embodiment is directed towards a chat server including the features of the twenty-sixth embodiment, wherein the chat room managing unit is further adapted to send a first notification to the chat client of the first device, the first notification comprising information about the created specific chat room being associated with the specific state of the activity application and that the user of the first device has entered the created specific chat room.

A thirtieth embodiment is directed towards a chat server including the features of the twenty-sixth embodiment, wherein the chat room managing unit is further adapted to determine if any specific chat room associated with the activated activity application set in the specific state already exists within the chat server, which specific chat room, if it exists, comprises at least one other user of a second portable communication device, that has activated an activity application set in the same specific state as the user of the first device.

A thirty-first embodiment is directed towards a chat server including the features of the thirtieth embodiment, wherein the chat room managing unit is further adapted to enter the user of the first device into the existing specific chat room if a specific chat room exists.

A thirty-second embodiment is directed towards a chat server including the features of the thirty-first embodiment, wherein the chat room managing unit is further adapted to send a first notification to the chat client of the first device, the first notification comprising information about the existing specific chat room being associated with the specific state of the activity application, that the user of the first device has entered the chat room and that the at least one other user of the second device also is in the specific chat room.

A thirty-third embodiment is directed towards a chat server including the features of the thirty-second embodiment, wherein the chat room managing unit is further adapted to send a second notification to each of the chat clients of at least one second device, the second notification comprising information that the user of the first device has entered the specific chat room.

A thirty-fourth embodiment is directed towards a chat server including the features of the thirty-second embodiment, where the chat server further comprises a chat session unit adapted to set up a chat session between the user of the first device and the at least one other user of the second device.

### BRIEF DESCRIPTION OF THE DRAWINGS

Embodiments of the invention will now be described in more detail in relation to the enclosed drawings, in which:

FIG. 1 schematically shows a first portable communication device communicating with a second communication device via an infrastructure network in an implementation consistent with the principles of the invention,

FIG. 2 is a block schematic of an exemplary portion of the first portable communication device of FIG. 1,

FIG. 3 is a block schematic of an exemplary portion of the chat server of FIG. 1,

FIG. 4 depicts a flow chart of an exemplary process performed in a first portable communication device,

FIG. 5 depicts a flow chart of an exemplary process performed in a chat server, and

FIG. 6 shows a CD ROM disc on which program code for executing a method according to the invention is provided.

### DETAILED DESCRIPTION OF EMBODIMENTS

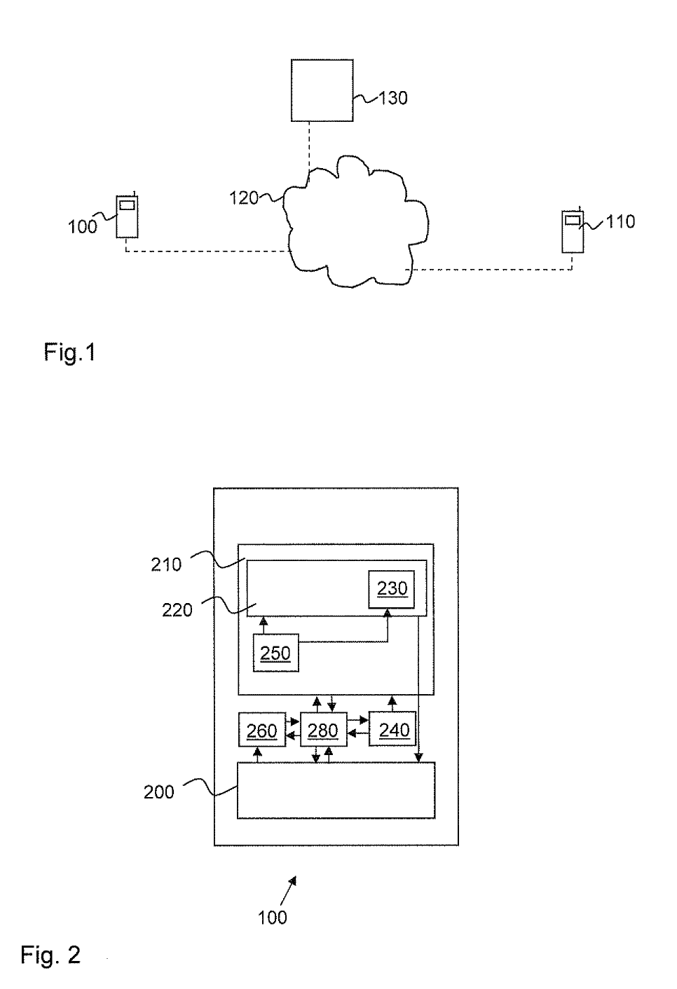

FIG. 1 schematically shows a first portable communication device 100 (referred to hereinafter as the first device 100), communicating with a second portable communication device 110 (referred to hereinafter as the second device 110) via a infrastructure network 120. The network 120 may include any type of network, such as, e.g., the Internet. The first and second communication devices 100 and 110 may be of the same type or different type of a portable communication device that are capable of communicating via the network 120 and send messages as well as engage in communication sessions involving instant messaging, i.e. chatting. For example, the first and second communication devices 100 and 110 may be a mobile phone or a personal digital assistant. A chat server 130, which is capable of managing “chat rooms,” may connect to network 120. The expression that the user of the first device 100 is chatting with the other user of the second device 110 is in this document defined as the user communicating with the other user, using text messages, voice and/or video communication. A chat room is in this document defined as a virtual room which contains a number of chatters. In order to chat with each other, two users “enter” the same chat room. The user of the first device 100 is capable of chatting with at least one other user of any second device 110 in a chat room within the chat server 130.

FIG. 2 shows an exemplary block diagram of the first device 100. The second device 110 may be similarly configured.

The first device 100 may include a chat client 200 adapted to set up a chat session between the user of the first device 100 and at least one other user of any second device 110 in a chat room, using text messages, voice and/or video communication.

The first device 100 may further include one or more activity applications 210, such as e.g., a music player, a video player, a video game engine, a camera application, a camcorder application, a web browser, a TV application, a main application of the device (e.g., the desktop or standby menu), etc. Each of the activity applications 210 may be placed into one or more states, X, Y, Z, (e.g., playing a specific song with a specific artist when the activity application 210 is a music player).

Each of the activity applications 210 may include a chat start application 220 adapted to trigger the chat client 200 to start a chat session between the first device 100 and the at least one other user of any second device 110. The chat starting application 220 may include a keyword generating unit 230 that generates specific keywords K, L, M, each being associated with a state X, Y, Z, of an ongoing application 210.

For example, if the ongoing activity application 210 is a music player and the state is that a specific artist singing a specific song is played, the keyword generating unit 230 may generate a specific keyword K associated with that specific application state that, in this example, is the played artist singing the specific song. In the same way, if another specific song with the same specific artist is played, another specific keyword L may be generated and associated with the played artist singing the other specific song. It is also possible that the keyword generating unit 230 generates a specific keyword M associated only with the played artist or only with the specific song.

As other examples, if the application 210 is a video game engine, a specific keyword may be generated and associated with the played game title and played game genre; if the application 210 is a web browser, a specific keyword may be generated and associated with a displayed Uniform Resource Locator (URL); and if the application 210 is a main application, a specific keyword may be generated and associated with a registered position of the first device, such as longitude and latitude of an activated user profile, such as meeting, office or outdoors.

The activity application 210 may include a first input device 240, such as, e.g., a keypad, a button, a screen icon, etc. When activated by the user, first input device 240 may trigger the start up of the activity application 210 (e.g., so that the user starts the music player). The first input device 240 may be arranged so that the user of the first device 100 can select a specific state X and can activate that specific state X of the activity application 210, e.g., play a song sung by a specific artist. When the specific state X is activated, the user of the first device 100 may wish to chat with another user that has activated the same state X of an activity application. The chat start application 220 may include a second input device 250, such as, e.g., a keypad, a button, a screen icon, etc. When activated by the user, second input device 250 may trigger the generation of a specific keyword K, associate it with the state X of the started activity application 210 and trigger the chat client 200 to start up a chat session between the first device 100 and the at least one other user of any second device 110.

The first and/or second devices 100 and 110 may communicate via a radio access network, such as, e.g., a WCDMA network, a GPRS or a GSM network or any third generation cellular network. In one embodiment of the invention, first and/or second device 110 may include the Sony Ericsson W900 cellular phone, which is able to connect to the Internet using Universal Mobile Telecommunications System (UMTS) and also include one or more activity applications, such as a camera, a video player, a music player, Java video game capabilities and/or a web browser. The chatting devices (e.g., devices 100 and 110) may not have equal activity functionality.

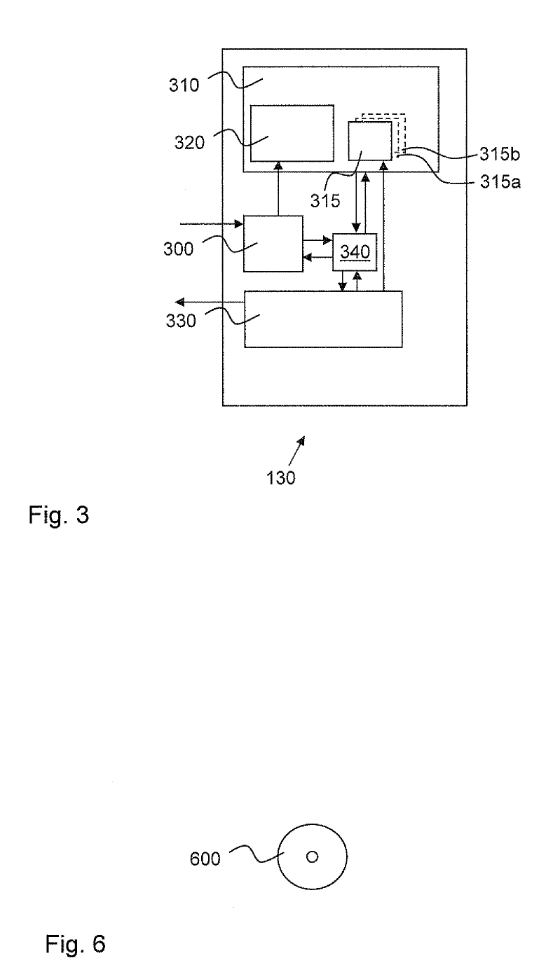

FIG. 3 shows a schematic view of an exemplary portion of the chat server 130. The chat server 130 may include a chat request receiving unit 300 that is adapted to receive a chat session request from the connecting chat client of the first device 100. The request may include the specific keyword K associated with the state X of the activated activity application 210 in the first device 100, the identity of the user of the first device 100 and possibly also the password of the user. The chat server 130 may further include a chat room managing unit 310, which is adapted to manage several chat rooms 315, 315a, 315b. The chat room managing unit 310 may include a keyword processing unit 320 that is adapted to process the received keyword K from the connecting chat client and identify the keyword K and which state X of the activated activity application 210 with which the keyword K is associated. The chat managing unit 310 is adapted to create a chat room 315 that is associated with the specific state X of the activated activity application 210 identified by the keyword processing unit 320. The chat room managing unit 310 first inquires whether a specific chat room 315 that is associated with the specific state X of an activity application activated by another user already exists before creating one. If no such specific chat room 315 exists, a specific chat room 315 may be created and the chat room 315, and the user of the first device 100 may be placed into the specific chat room 315 as the first chatter in that specific chat room 315.

In a subsequent scenario, the chat request receiving unit 300 may receive a chat request from another user of a second device 110, where the request includes a keyword L associated with the same state X as the first device 100 of an activated application of same type as in the first device 100. The keyword processing unit 320 processes the received keyword L from the connecting chat client of the second device 110 and identifies the keyword L and in which state X the activated activity application 210 is set. The chat room managing unit 310 inquires whether a specific chat room 315 that is associated with the specific state X of an activity application activated by another user already exists. In this case, such a specific chat room 315 already exists in which chat room the user of the first device has entered to, and no new chat room will therefore be created. A chat session 330 may be set up between the second device 110 and the first device 100, which may be performed by the chat session unit 320. The other user of the second device 110 now has the possibility to chat with the user of the first device 100 in the specific chat room 315 that is associated with the specific state X of the activated activity application 210 identified by the keyword processing unit 320.

It is of no importance whether the communication between the first device 100 and the second device 110 is performed via the chat server 130 or peer-to-peer. The keyword may define which chat room to enter for a chat requesting user. In other words, if two users of communication devices which contain software for the procedure activates the procedure during the same activity they will end up in a common chat session. There is no limit for the amount of distinguishable activities and thus no limit for the amount of different potential chat sessions. There is furthermore no limit to the number of users engaged in the same chat session.

Thus, depending on which application is starting the chat client, the user may end up in a certain chat room. The application which generates the keyword is also allowed to make it depend on any state in the application. It is also possible that an existing chat client on a device may be modified so as to provide the solution according to implementations consistent with the invention.

While the user is using an application with a certain state in the device and that application is capable to generate a keyword and start the chat client, it is possible for the user to start a chat session with whoever is also using a corresponding application with an equivalent state and has started the chat client in this state.

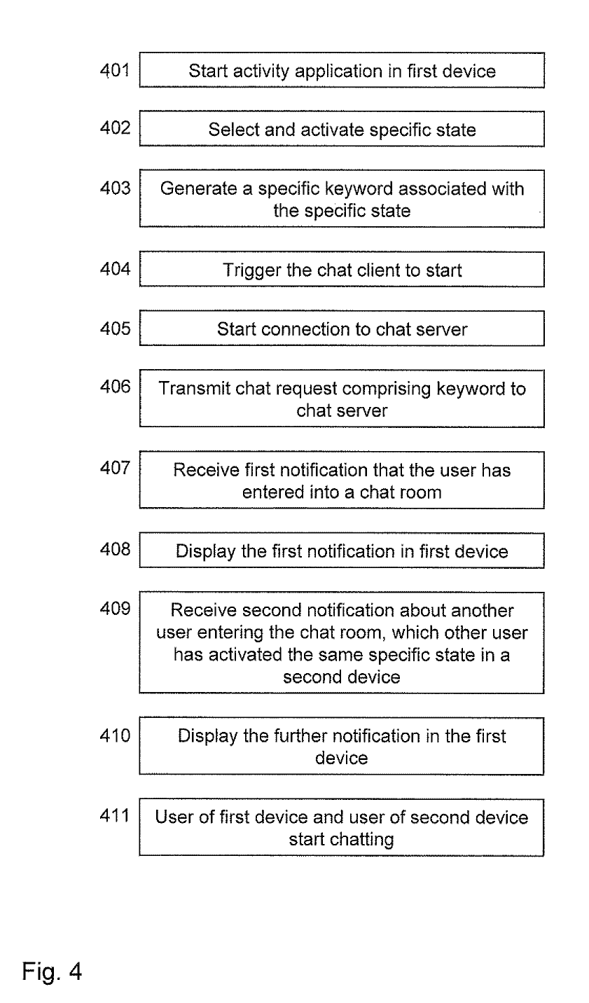

An exemplary process performed in the first device 100 will now be described with reference to the flow chart in FIG. 4. Processing may begin with the activity application 210 in the first device 100 being activated by the user and the activity application entering an idle state (block 401). For example, a music player in a mobile phone may be activated and the music player may enter the state <IDLE>.

The user may select and activate a specific state of the activity application 210 (block 402). The activity application 210 may enter the activated state, which means that the activity application 210 is set in a specific state. For example, the user may select the song Talk by Coldplay and then starts playing it. The music player may enter state <PLAY ARTIST=“Coldplay” SONG=“Talk”>.

When the user wishes to chat, he/she may activate the second input device 250, which activation triggers the chat start application to generate a specific keyword associated with the specific state of the activity application 210 (block 403). The activated second input device may further trigger the chat client 200 to start with the specific keyword as a parameter (block 404).

The chat client 200 may start a network connection and then a connection to the chat server 130 (block 405).

The chat client 200 may send a chat request to the chat server 130 (block 406). The request may include the specific keyword and the user name and password of the user.

The chat client 200 may receive a first notification from the chat server 130 (block 407), where the first notification includes information about a created specific chat room in the chat server. In one implementation consistent with principles of the invention, the specific chat room 315 is associated with the specific state of the activity application defined by the specific keyword. The first notification further includes information that the user has entered into the specific chat room 315.

The chat room 315 may be displayed to the user of the first device 100 (block 408), e.g., shown in a display of the first device 100.

The chat client 200 may receive a second notification from the chat server 130 (block 409). The second notification may include information whether another user of a second device 110 is in the specific chat room 315 associated with the specific state of the activity application 210, which other user has activated the same specific state of an activity application in the second device 110.

An identity of the other user being in the specific chat room may be displayed to the user of the first device 100 (block 410), e.g., shown in a display of the first device 100.

A chat session may be set up between the first device 100 and second device 110 and the user of the first device 100 and the other user of the second device 110 may start chatting (block 411).

To perform the above processing, the first device 100 may include the components illustrated in FIG. 2. The first device 100 may include a chat client 200 and an activity application 210, where activity application 210 is settable in a state. The activity application may include a chat start application 220. The first device 100 may be adapted to connect to a chat server 130 via an infrastructure network 120. The first device 100 may include a first input device 240 adapted to activate the activity application and set the activated activity application in a specific state. The activity application 210 may include a second input device 250 for activating the chat start application 220, which when activated, may be adapted to trigger a keyword generating unit 230 to create a specific keyword associated with the activated activity application set in a specific state, and which further when activated may be adapted to trigger the chat client 200 to send a chat request to the chat server. The chat request includes the specific keyword.

The chat client 200 may be adapted to receive a first notification from the chat server 130. The first notification may include information about a created specific chat room 315 in the chat server 130. (The chat room 315 is shown in FIG. 3.) The specific chat room 315 is associated with the specific state of the activity application defined by the specific keyword. The first notification may further include information that the user of the first device 100 has entered into the specific chat room 315. The chat client 200 may further be adapted to receive a second notification from the chat server 130, where the second notification includes information about another user of a second device 110 being in the specific chat room 315, which other user has activated the same specific state of an activity application in the second device 110. The chat client may further be adapted to set up a chat session between the first device 100 and the second device 110 in the specific chat room 315.

The first device 100 may further include a display device 260 adapted to display the specific chat room to the user of the first device and may further display an identity of the other user being in the specific chat room 315.

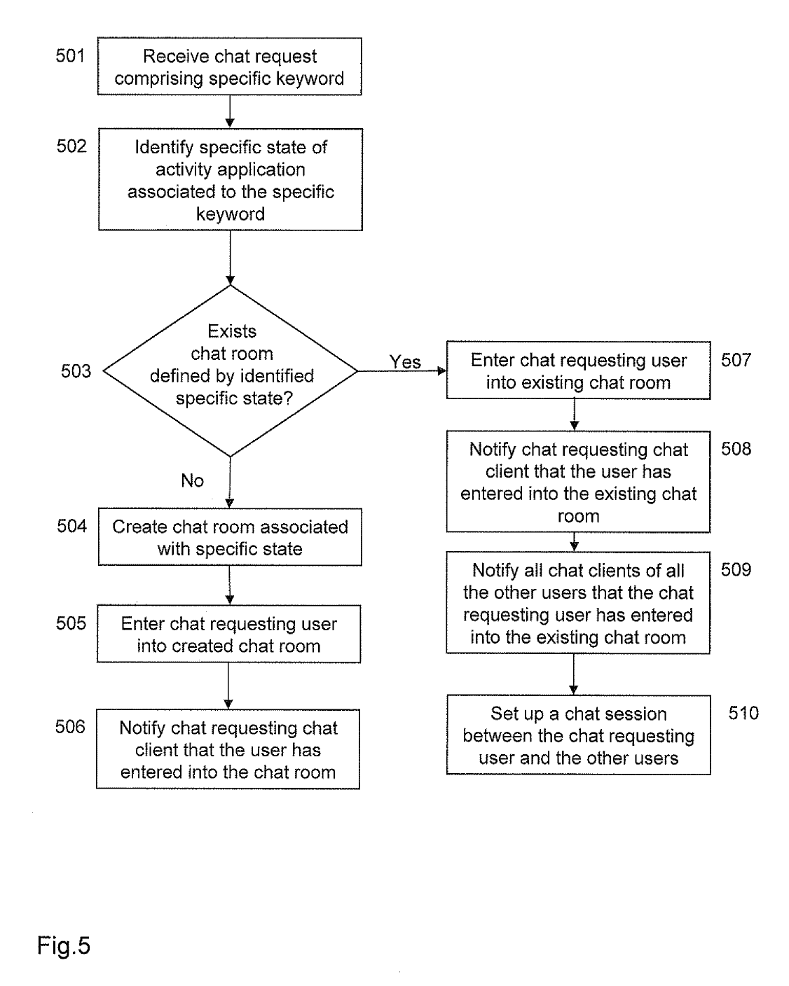

Exemplary processing performed in the chat server 130 will now be described with reference to the flow chart in FIG. 5. Processing may begin with the chat request receiving unit 300 in the chat server 130 receiving a chat request from a chat client in the first device 100 (block 501). The request includes the specific keyword associated with the specific state of an activity application that is activated in the first device 100 and the request may further include the username and password of the user of the first device 100.

The specific keyword may be processed within the keyword processing unit 320 (block 502). The processing may include identifying the specific state of the activity application associated with the keyword.

The keyword processing unit 320 may determine if any specific chat room associated with the activity application set in the specific state already exits within the chat server 130 (block 503). If the chat room exists, the chat room includes at least one other user of a second portable communication device 110 that has activated an activity application set in the same specific state as the user of the first device 100.

If no specific chat room defined by the specific keyword is found, the chat room managing unit 310 in the chat server 130 may create a specific chat room 315 that is associated with the specific state of the activity application according to the specific keyword (block 504).

The chat room managing unit 310 may place the user of the first device 100 into the chat room 315 (block 505).

The chat room managing unit 310 may send a first notification to the chat client of the first device 100 (block 506). The first notification may include, for example, information about the created specific chat room 315 being associated with the specific state of the activity application and that the user of the first device 100 has entered the created specific chat room 315.

If the specific chat room 315 defined by the specific keyword is found, the chat room managing unit 310 enters the user of the first device 100 into the chat room 315 (block 507).

The chat room managing unit 310 may send a first notification to the chat client of the first device 100 (block 508). The notification may include, for example, information about the existing specific chat room 315 being associated with the specific state of the activity application, that the user of the first device 100 has entered the existing specific chat room, and that the at least one other user of the second device 110 also is in the existing specific chat room 315.

The chat room managing unit 310 may send a second notification to each of the chat clients of the at least one second device 110 (block 509). The second notification may include, for example, information that the user of the first device 100 has entered the specific chat room 315.

The chat session unit 330 may set up a chat session between the user of the first device 100 and the at least one other user of the second device 110.

To perform the above processing, the chat server 130 may be configured as depicted in FIG. 3. The chat server 130 may be adapted to communicate with a chat client in a first portable communications device 100 via the infrastructure network 120. The chat server 120 may also be adapted to communicate with a chat client in at least one second portable communications device 110, via the infrastructure network 120. The chat server 130 may include a chat request receiving unit 300 adapted to receive from the chat client of the first device, a chat request including a specific keyword. The specific keyword is associated with an activated activity application set in a specific state by a user of the first device.

The chat server 130 may also include a keyword processing unit 320 adapted to identify the specific state of the activity application associated with the specific keyword.

The chat server 130 may further include a chat room managing unit 310 adapted to create a specific chat room 315 associated with the specific state of the activity application according to the specific keyword, and may be adapted to enter (or place) the chat requesting user into the created specific chat room 315. The chat room managing unit 310 may further be adapted to send a first notification to the chat client of the first device 100, where the first notification includes information about the created specific chat room 315 being associated with the specific state of the activity application and that the user of the first device 100 has entered the created specific chat room 315,

The chat room managing unit 310 may also be adapted to determine if any specific chat room 315 associated with the activated activity application set in the specific state already exits within the chat server 130 before creating the chat room. The specific chat room, if it exists, includes at least one other user of a second portable communication device 110, that has activated an activity application set in the same specific state as the user of the first device 100. The chat room managing unit 310 is further adapted to enter the user of the first device into the existing specific chat room if a specific chat room exists.

The chat room managing unit 310 may be further adapted to send a first notification to the chat client of the first device. The first notification may include information about the existing specific chat room being associated with the specific state of the activity application, that the user of the first device has entered the chat room and that the at least one other user of the second device also is in the specific chat room 315. The chat room managing unit 310 may further be adapted to send a second notification to each of the chat clients of the at least one second device 110. The second notification may include information that the user of the first device 100 has entered the specific chat room 315.

The chat server 130 may further include a chat session unit 330 adapted to set up a chat session between the user of the first device 100 and the at least one other user of the second device 110.

The above processing can be implemented through one or more processors, such as the processor 260 in the first device 100 depicted in FIG. 2 and the processor 340 in the chat server 130 depicted in FIG. 3, together with computer program code for performing the functions of the invention. The program code mentioned above may also be provided as a computer program product, for instance, in the form of a data carrier carrying computer program code for performing the above processing, when being loaded into first device 100 and/or the chat server 130. One such carrier 600, in the form of a CD ROM disc is generally outlined in FIG. 6. It is, however, feasible with other data carriers, such as a memory stick. The computer program code can furthermore be provided as pure program code on a server and downloaded to the access point and/or user equipment remotely.

It should be emphasized that the term “comprises/comprising” when used in this specification is taken to specify the presence of stated features, integers, steps or components, but does not preclude the presence or addition of one or more other features, integers, steps, components or groups thereof.

While the above description focused on providing media data from a first portable communication device to a second portable communication device, implementations, consistent with principles of the invention are not so limited. For example, in some embodiments of the invention, the first portable communication device may broadcast the media data to a group of second portable communication devices.

While series of acts have been described with respect to FIGS. 4 and 5, the order of the acts may be varied in other implementations consistent with the invention. Moreover, non-dependent acts may be implemented in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. Method in a first portable communication device, for managing a chat room, the first portable communication device comprising a chat client, an activity application, and a chat start application, the first portable communication device being adapted to connect to a chat server, the method comprising:
activating the activity application;
setting the activated activity application to a specific state;
activating the chat start application;
creating, in response to the activating of chart start application, a specific keyword associated with the activated activity application set in a specific state; and
sending, in response to the activating the chat start application, a chat request to the chat server, the chat request comprising the specific keyword.

2. Method according to claim 1, further comprising:
receiving a first notification from the chat server, the first notification comprising information about a specific chat room in the chat server, the specific chat room being associated with the specific state of the activity application defined by the specific keyword.

3. Method according to claim 1, wherein said first notification further comprises information that the user of the first device has entered the specific chat room.

4. Method according to claim 1, further comprising:
displaying the specific chat room to the user of the first device.

5. Method according to claim 1, further comprising:
receiving a second notification from the chat server, the second notification comprising information about another user of a second device being in the specific chat room, which other user has activated a same specific state of an activity application in the second device.

6. Method according to claim 5, further comprising:
displaying an identity of the other user being in the specific chat room.

7. Computer program product for managing a specific chat room, comprising computer program code for causing a processing means within the first portable communication device to control an execution of the method of claim 1.

8. A first portable communication device comprising:
a chat client;
an activity application that is settable in a state;
a chat start application;
a first input device adapted to activate the activity application and set the activated activity application in a specific state;
a second input device for activating the chat start application; and
a keyword generating unit for creating, in response to the chat start application being activated, a specific keyword for the activated activity application set in a specific state,
the chat client sending a chat request to the chat server in response to the chat start application being activated, the request comprising the specific keyword.

9. The first portable communication device according to claim 8, wherein the chat client is adapted to receive a first notification from the chat server, the first notification comprising information about a specific chat room in the chat server, the specific chat room being associated with the specific state of the activity application defined by the specific keyword.

10. The first portable communication device according to claim 8, wherein said first notification further comprises information that the user of the first portable communication device has entered the specific chat room.

11. The first portable communication device according to claim 8, further comprising:
a display device adapted to display the specific chat room to the user of the first portable communication device.

12. The first portable communication device according to claim 8, wherein the chat client further is adapted to receive a second notification from the chat server, the second notification comprising information about another user of a second device being in the specific chat room, which other user has activated a same specific state of an activity application in the second device.

13. The first portable communication device according to claim 11, wherein the display device is further adapted to display an identity of the other user being in the specific chat room.

14. The first portable communication device according to claim 12, wherein the chat client further is adapted to set up a chat session between the first portable communication device and the second device in the specific chat room.

15. The first portable communication device according to claim 8, wherein the first portable communication device is a mobile phone.

16. A method comprising:
receiving, from a chat client of a first portable communication device, a chat request comprising a specific keyword, the specific keyword being associated with an activated activity application set in a specific state by a user of the first portable communication; and
creating a specific chat room associated with the specific state of the activity application according to the specific keyword, if no such chat room already exists.

17. Method according to claim 16, further comprising:
identifying the specific state of the activity application associated with the specific keyword.

18. Method according to claim 16, further comprising:
entering the user into the created specific chat room.

19. Method according to claim 16, further comprising:
sending a first notification to the chat client of the first portable communication device, the first notification comprising information about the created specific chat room being associated with the specific state of the activity application and that the user of the first portable communication device has entered the created specific chat room.

20. Method according to claims 16, further comprising:
determining if any specific chat room associated with the activated activity application set in the specific state already exits within the chat server, which specific chat room, if it exists, comprises at least one other user of a second portable communication device, that has activated an activity application set in a same specific state as the user of the first portable communication device.

21. Method according to claim 20, further comprising:
if a specific chat room exists, entering the user of the first portable communication device into the existing specific chat room.

22. Method according to claim 21, further comprising:
sending a first notification to the chat client of the first portable communication device, the first notification comprising information about the existing specific chat room being associated with the specific state of the activity application, that the user of the first portable communication device has entered the chat room and that the at least one other user of the second portable communication device also is in the specific chat room.

23. Method according to claim 21, wherein the chat server is adapted to communicate with a chat client in at least one second portable communications device via the infrastructure network, and the method further comprising:
sending a second notification to each of the chat clients of the at least one second portable communication device, the second notification comprising information that the user of the first portable communication device has entered the specific chat room.

24. Method according to claim 21, further comprising:
setting up a chat session between the user of the first portable communication device and the at least one other user of the second portable communication device.

25. Computer program product for managing a specific chat room, comprising computer program code for causing a processing means within the chat server to control an execution of the method of claim 16.

26. A chat server comprising:
a chat request receiving unit adapted to receive from a chat client of a first device, a chat request comprising a specific keyword, the specific keyword being associated with an activated activity application set in a specific state by a user of the first device; and
a chat room managing unit adapted to create a specific chat room associated with the specific state of the activity application according to the specific keyword.

27. The chat server according to claim 26, further comprising:
a keyword processing unit adapted to identify the specific state of the activity application associated with the specific keyword.

28. The chat server according to claim 26, wherein the chat room managing unit is further adapted to enter the user into the created specific chat room.

29. The chat server according to claim 26, wherein the chat room managing unit is further adapted to send a first notification to the chat client of the first device, the first notification comprising information about the created specific chat room being associated with the specific state of the activity application and that the user of the first device has entered the created specific chat room.

30. The chat server according to claim 26, wherein the chat room managing unit is further adapted to determine if any specific chat room associated with the activated activity application set in the specific state already exists within the chat server, which specific chat room, if it exists, comprises at least one other user of a second portable communication device, that has activated an activity application set in the same specific state as the user of the first device.

31. The chat server according to claim 30, wherein the chat room managing unit is further adapted to enter the user of the first device into the existing specific chat room if a specific chat room exists.

32. The chat server according to claim 31, wherein the chat room managing unit is further adapted to send a first notification to the chat client of the first device, the first notification comprising information about the existing specific chat room being associated with the specific state of the activity application, that the user of the first device has entered the chat room and that the at least one other user of the second device also is in the specific chat room.

33. The chat server according to claim 32, wherein the chat room managing unit is further adapted to send a second notification to each of the chat clients of the at least one second device, the second notification comprising information that the user of the first device has entered the specific chat room.

34. The chat server according to claim 32, further comprising:
a chat session unit adapted to set up a chat session between the user of the first device and the at least one other user of the second device.
